(19) United States
(12) Patent Application Publication
(10) Pub. No.: US 2008/0094843 A1
(43) Pub. Date: Apr. 24, 2008

(54) Optical device for producing lines of light from quasi-point sources of light by means of slit-like cavities

(76) Inventors: Frederic Zweig, Zurich (CH); Thomas Buhrer, Zurich (CH)

Correspondence Address: MAGINOT, MOORE & BECK, LLP;CHASE TOWER, 111 MONUMENT CIRCLE, SUITE 3250, INDIANAPOLIS, IN, 46204, US

(21) Appl. No.: 11/811,385

(22) Filed: Jun. 8, 2007

Related U.S. Application Data
(63) Continuation of application No. PCT/CH2005/000722, filed on Dec. 5, 2005.

(30) Foreign Application Priority Data
Dec. 8, 2004 (CH) 2038/04

(51) Int. Cl. G02B 5/02

(52) U.S. Cl. 362/297

(57) ABSTRACT

An optical device is disclosed for producing light lines. The optical device comprises at least one quasi point-like light source. The optical device further comprises a transparent, light guiding body configured such that light from the at least one quasi point-like light source is led through the body. The light from the at least one quasi point light source is beamed in at a first front end of the body, and is beamed out again essentially at an opposite, second front end of the body. Slot-like cavities provided in the body reform the beamed-in light in a manner such that the body acts as a combination of a reflector with lens optics and a light scatterer.

### CROSS-REFERENCE TO RELATED APPLICATIONS

The present application is a continuation of international patent application number PCT/CH2005/000722, filed Dec. 5, 2005, designating the United States, and which claims priority from Switzerland application number 2038/04, filed Dec. 8, 2004.

### FIELD

The present application discloses optical devices and an optical method. It particularly relates to an optical device for producing light lines by way of quasi point-like light sources.

### BACKGROUND

Optical devices are known, with the help of which, light from quasi point-like light sources such as LEDs or optical fibres, is provided in a more or less continuously appearing line shape.

With these optical devices, a dense row of quasi point-like light sources are arranged behind a more or less milky disk, such that no or only minimal intermediate spaces between the individual light sources exist. This demands a large number of quasi point-like light sources, which entails a significant financial expense. The light from the quasi point-like light sources is distributed by way of scattering on a rough/milky disk, such that the light emitted by the optical device is relatively homogenous. The losses due to backscatter/reflectance and/or absorption with the passage of light through the scatter disk are however considerable, and the optical devices therefore only provide quite diffuse light of an inadequate range. With these devices, as a rule, it is not possible to define or limit the distribution of the light intensity and the propagation direction of the light. The diffusity further leads to the light intensity decreasing very rapidly with an increasing distance to the optical device.

### SUMMARY

In view of the foregoing, it would therefore be advantageous to provide an optical device with which the light may be converted from a few discrete quasi point-like light sources, into an extended light line. Thereby, preferably the light intensity is distributed over the light line as homogenously as possible, and the light emitted by the optical device is preferably defined and directed to a high percentage in its emitting direction. In particular, this is to be achieved for light sources, whose emitting light has a variable aperture angle between 0 to 90°, depending on the light source, wherein the angle between the middle normal of the emitting plane and the cone of light for which the light intensity is <5% of the total intensity, is considered as the aperture angle. In another further advantageous embodiment, it is possible with the optical device to mix light from quasi point-like light sources of a different colour arranged next to one another, such that it is emitted from the optical device as light of a colour which is defined previously in an exact manner, or is incident as light of a previously defined colour, onto a surface to be illuminated.

In a further advantageous embodiment, the optical device may be an optical body with a linear light exit surface, which may be straight or curved. The intensity distribution of the point-like light sources arranged distanced to one another is advantageously regulated in the optical device, such that the total impression of a homogenous line or one which is fashioned in a conscious manner in another way, arises. The light from the discrete light sources is distributed onto the whole length between the sources, as well as into the region directly above the light sources. The sources themselves are thus not visible.

The distance of the discrete light sources may be selected in a relatively free manner, wherein the depth of the optical base body is above all dependent on the light distribution to be achieved, on the material, on the number of light sources and on the emitting angle of the light proceeding from the light sources The minimal depth of the base body increases with an increasing emitting angle and an increasing number of light sources.

Complexly shaped cavities matched to one another in an exact manner are provided in the preferably plate-like, optical base body of the optical device, which are preferably introduced by laser, as thin, slot-like incisions. These slot-like cavities have a finite thickness of 0.05 mm to 2 mm, in particular of 0.1 mm to 1 mm. They form preferably continuous cavities which run perpendicularly to plane of the plate of the plate-like base body. The slot-like cavities act as optical elements, on which the light, depending on the angle of incidence, is reflected with total reflection, or through which it is beamed in a targeted manner. They always act according to the laws of light refraction, light diffraction and beam optics, as beam splitters, lenses and/or mirrors, wherein they may indeed have these different effects simultaneously, depending on the angle of incidence of the light. The effect as an optical lens thereby certainly occurs rather seldomly, and therefore mostly but not always, may be neglected. The total effect of the device may however be the same as lens optics, which is achieved with the help of reflecting surfaces (total reflection).

The slot-like cavities are advantageously arranged such that a single body with a multitude of slot-like cavities arise, wherein several slot like cavities may always be grouped together into a group, and the individual groups may have the effect of specific optical units.

For example, one group serves for guiding and deflecting the light from the entry region of the light, into the middle of the optical body, and another group serves for the final light distribution from the light exit surface of the optical body.

A long, slot-like cavity indicated as a base and extending in the longitudinal direction of the base body, regionally divides the base body of the optical device into a space through which the light beams, and a space through which the light does not beam. Thereby, it extends away from an associated light source in the longitudinal direction, such that in each case it covers at least one adjacent light source Q, and at the same time forms an optical barrier between the adjacent light source and the light exit surface. The light of the associated light source on the other hand is deflected via the light entry surface and further slot-like cavities—which may form a first and a second group, which also act as optical units—into the respective space beamed through by light, on the light exit side of the base. In this manner, one prevents the quasi point-like light sources being perceived as point-like light sources in the region of the light exit surface. The inclination of the base with respect to the first front end is dependent on the light share which is reflected via the first front end and which is to be transmitted further in the body. Smaller slot-like cavities which belong to the same group as the base and which may be subdivided into root, trunk and crown, finally serve for the fine setting of the light guided to the exit surface, with regard to its intensity, distribution, alignment etc. They thus significantly effect the final light distribution at the exit surface. The light exit surface itself may in turn be shaped in a special manner, similarly to the light entry surface, in order once again to modify the exiting light.

In a preferred embodiment, when the slot-like cavities are for example introduced into the base body by cutting, for example with a laser, the distance between individual slot-like cavities is at least three times as large as the section thickness of the laser, or the width of the resulting slot-like cavity.

The slot-like cavities in many cases are of a great complexity, i.e. the course of the slot, instead of following a straight line or a simple curvature with a constant radius, may also follow a combination of curves of different radii and straight part stretches, wherein the curvatures may be composed of the smallest of straight part stretches. Common problems such as edge effects and dispersion problems are circumvented by way of the use of slot-like cavities in the context of arcuate mirrors.

In a particular embodiment, the light in the optical device is deflected and mixed through, such that after the passage through the optical device, it is emitted from each point of the optical devices in a measurable and directed manner which is predefined at least to 90%, wherein the emitted light is not diffuse, preferably by more than 85%, and the direction distribution and intensity distribution of the light is measurable according to the specifications within defined tolerances, due to the geometry of the body and the geometry and arrangement of the slots, and may be set.

Losses caused by the optics are very small (with an optical coating of the entry surfaces 1 and exit surfaces 5, the loss is <5%). This is because the effect is achieved by way of total reflection, which functions in a loss-free manner. Furthermore, no problems with dispersion arise, since light of all wavelengths is deflected in an exactly equal manner.

If light of different colours is to be mixed, the light from the individual, differently coloured light sources is directed by way of entry optics and by way of a first group of slot-like cavities which form a first optical unit, such that the light paths begin to cross. The radiation of this light onto a second group of slot-like cavities, which form a second optical unit, is thus advantageously effected already as mixed light. This mixed light is then led further through the second group of slot-like cavities in a manner such that the imaging of the original light sources comes to coincide in the region of a third group of slot-like cavities. I.e. the light to be intermixed from all light sources is now present in a distributed manner in the base body in the space between different discrete light sources, in a previously defined distribution.

The light of all colours radiated in, thus comes from many different directions, so that the images of the original light sources coincide, and are no longer visible as individual images.

It is clear that the man skilled in the art is provided with a very flexible tool with this optical device, and its diverse embodiments, in order to influence light from discrete light sources emitting directed light, in its propagation direction as well as in its intensity distribution, in dependence on the direction, or also in its phase shift.

It would be desirable to provide a device that provides one or more of these or other advantageous features as may be apparent to those reviewing this disclosure. However, the teachings disclosed herein extend to those embodiments which fall within the scope of the appended claims, regardless of whether they accomplish one or more of the above-mentioned advantages.

### BRIEF DESCRIPTION OF THE DRAWINGS

The subject-matter herein is explained hereinafter in more detail by way of preferred embodiment examples which are represented in the figures.

FIG. 1 shows a basic sketch of a quasi point-like light source;

FIG. 2 shows in a lateral view, a first embodiment of the optical device according to at least one embodiment of the invention;

FIG. 3 is an enlarged cut-out from FIG. 2 with optically effective cavities designed according to at least one embodiment of the invention,

FIG. 4 shows the optical device of FIG. 2, with drawn-in light paths;

FIG. 5 shows in a lateral view, a second embodiment of the optical device according to at least one embodiment of the invention;

FIG. 6 shows in a lateral view, a further embodiment of the optical device according to at least one embodiment of the invention; and

FIG. 7 shows the embodiment of the optical device of FIG. 6 with drawn-in light paths.

The described embodiments represent the subject-matter of various embodiments of the invention by way of example, and have no limiting effect. It is clear to the man skilled in the art as to which manner the device may be modified in a purposeful manner, without departing from the scope of the invention. Equal elements are characterised with the same reference numerals in the different figures.

### DETAILED DESCRIPTION

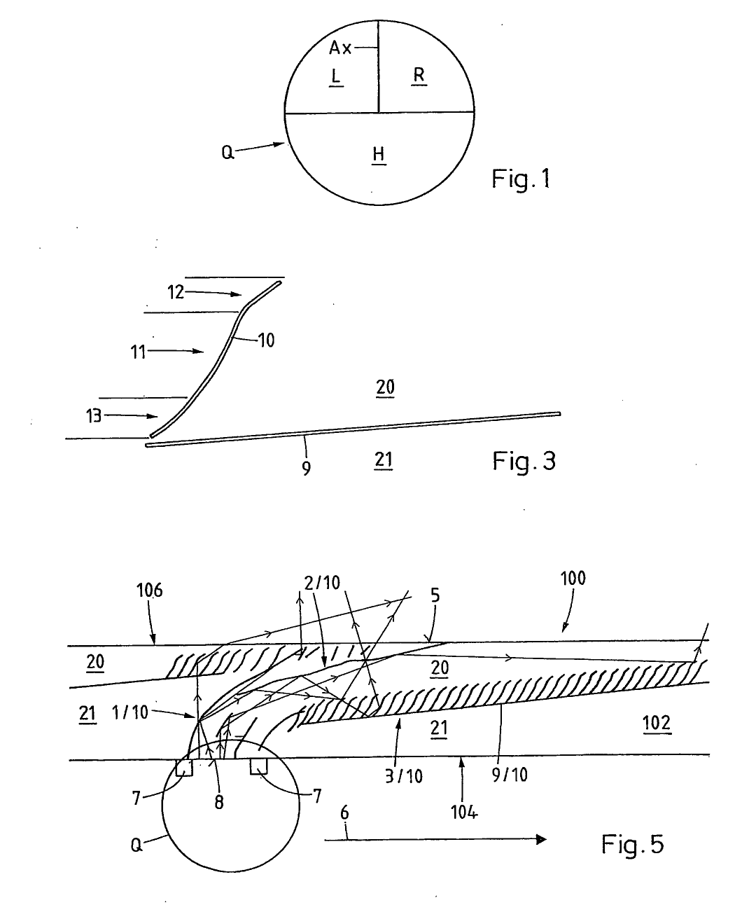

FIG. 1 shows a basic sketch of a quasi point-like light source Q, as is used for the optical device according to the invention. The quasi point-like light source Q has a rear side H via which no light exits, and a front side which is here divided into two sectors L and R by a central axis Ax of the light emitting, and via which sectors the light is emitted. The light which is emitted from the quasi point-like light sources preferably has an aperture angle of 0° up to 90°, wherein the angle between the middle normal of the emitting plane Ax and the cone for which the light intensity <5% of the total intensity, is considered as the aperture angle. LEDs and/or fibre optics are particular well applicable as quasi point-like light sources of the described type.

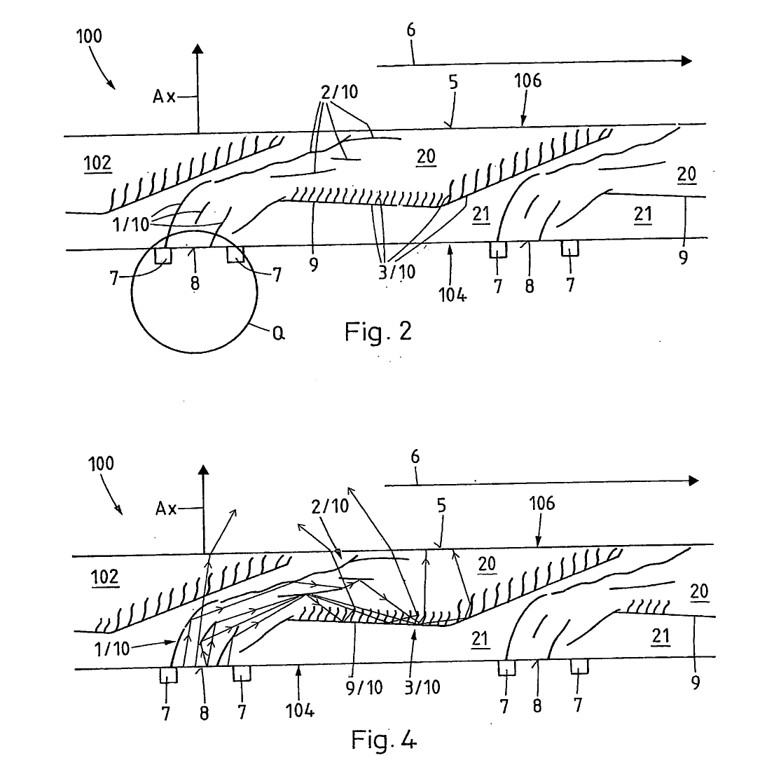

FIGS. 2 and 4 in a lateral view show a first embodiment form of the optical device 100 according to the invention, wherein the light path is drawn in FIG. 4. The optical device 100 comprises an elongate, plate-like, transparent light-guiding base body 102 with a thickness of—in this example—about 9 mm, wherein the thickness may lie in a region of 0.5 mm to 20 mm. The plate in this example has a right-angled basic geometry, but may also have any other basic geometry. A first front end 104 extending in the longitudinal direction 6 of the plate 102 serves for coupling in light. For this, positioning aids 7, e.g. in the form of pegs or holes, which fix the light sources Q, such as LEDs and/or fibre optics in positions suitable for coupling in light, are provided on the front end 104. The light sources in this example are arranged in groups of three directly adjacent light sources at a distance of about 90 mm to one another, but may be arranged within a very wide region of distances, specifically roughly distances from 0 mm to 1000 mm along the first front end 104.

The front end 104 may be formed as a light entry surface 8 at those locations of the first front end 104 which are provided for the coupling-in of light, in order to achieve an optimised coupling-in of light. The light entry surface 8 for this purpose may be shaped in an infinite manner, e.g. as Fresnel lens, hologram or as a simple optical lens. The geometry of the light entry surface 8 effects an exact manipulation of light, which forms the propagation direction and the intensity distribution of the light beams coming from the light source Q, such that they may be processed further in an optimal manner. In most cases, this means that the light beams are chiefly parallelised, in order as a result of this, to be able to distribute them further in an optimal manner. However, scenarios are also conceivable, in which the light beams of a light source Q are divided, defocused, shifted in their phase or focussed into a focal point, in order to direct them further, and to let them exit from the optical device according to the final purpose. In the example shown here, the light entry surface 8 is designed as a weakly focussing lens, which slightly aligns the weakly diverging beams of the light sources Q used here, for a first time.

The light which is beamed in, is homogenised at a second front end 106 extending in the longitudinal direction 6 of the optical device 100 and lying essentially opposite the first front end 104, and is preferably coupled out and emitted in a preferably directed manner via a light exit surface 5.

Slot-like cavities 10 with polished surfaces are provided between the two front ends 104, 106 for the homogenisation and alignment of the light, and these surfaces act as optical elements in the transparent body 102 guiding light. The slot-like cavities 10 are shaped in a complex manner and are matched to one another. In this example, they have a width of about 0.3 mm. Generally, the width of the slot-like cavities 10 may lie in the region of about 0.05 mm to 2 mm and in particular in the region of 0.1 mm to 1 mm. In this example, the cavities 10 are designed as continuous slots, but may however also be designed as non-continuous grooves. The slot-like cavities 10 in this example extend perpendicularly to the plate plane of the plate-like base body 102. However, a different alignment is also conceivable, i.e. the slots 10 may extend into the body 102 or through it, at a defined angle to the plane of the plate. The slot-like cavities 10 act as optical elements 1, 2, and 3 at which the light, depending on the angle of incidence, is reflected by total reflection, or is beamed through in a targeted manner. They always act according to the laws of light refraction, light diffraction and beam optics, as beam splitters, lenses and/or mirrors, wherein they may indeed also have these different effects simultaneously, depending on the angle of incidence of the light. The slot width is essentially determined by the situation with regard to manufacturing technology, and may otherwise be varied in a relatively free manner.

The slot-like cavities 10 form groups 2, 3, 4 which have the effect of specific optical units. The slot-like cavities 10 of a first optical unit 1 on the one hand effect a targeted deflection and focussing of the light coming from the light entry surface 8. On the other hand, all beams which impinge the slot-like cavities 10 at a greater angle than the angle of total reflection, are transmitted, so that a beam splitting is effected. Transmitted light reaches the slot-like cavities 10 of the third optical unit 3. Light reflected or deflected at the slot-like cavities 10 of the first optical unit 1, beams onto the slot-like cavities 10 of the second optical unit 2. The second optical unit 2 effects a propagation direction distribution and intensity distribution, such that on the one hand the slot-like cavities 10 of a third optical unit 3 which act as optical elements are irradiated in a predefined manner, and on the other hand that a part of the light, again via the slot-like cavities 10 of the second optical unit 2, exits through the exit surface 5 of the second front end 106, out of the optical base body 102.

Thereby, the design of the slot-like cavities 10 of the second optical unit 2 with the different straight parts and the different defined curve radii, is matched exactly to the desired distribution, e.g. concerning the intensity, alignment and the emitting angle/angles.

Convex radii, which are utilized with the slot-like cavities 10 indicated at 2, effect a defocusing of the beams coming from the light entry surface 8, concave ones effect a focussing, and plane, slot-like cavities 10 effect an undistorted image, according to the laws of beam optics.

The greatest part of the light reflected via the second optical unit 2 in the example shown in FIGS. 2 and 4, is deflected into the space sector R, and has a predefined direction—and intensity distribution.

The light is once again changed in its propagation direction distribution and intensity distribution, at the third optical unit 3, and depending on the desired final distribution, is defocused, focussed, divided up into several beams; that is to say, as a complicated light distribution curve is made to emit via the light exit surface 5 of the second front end 106. In the third optical unit 3, one may differentiate a long, continuous, slot-like cavity 10 extending essentially in the direction of the longitudinal extension 6 of the plate-like base body 102, which is indicated as the base 9, and many short slot-like cavities 10. The short, slot-like cavities 10 are subdivided into three regions, as is shown in the enlarged representation of FIG. 3. These are a region facing the base 9 which is indicated as the root 13, a middle region connecting thereto which is indicated as the trunk 11, and a region connecting to this trunk 11 indicated as a crown 12. The short slots 10 extend from the base 9 essentially in the direction towards the exit surface 5.

The bases 9 of the third optical units 3 divide the base body 102 of the optical device 100 regionally into a space 20 beamed through by light, and into a space 21 which is not beamed through by light, wherein the space 10 beamed through by light lies facing the light exit surface 5, and the space 21 which is not or hardly beamed through by light, is arranged on the side of the body at which the light is coupled in. Each base 9 thereby extends away from an associated light source Q in the direction of the main axis 6 of the base body 2, such that it in each case covers at least one adjacent light source Q, and simultaneously forms an optical barrier between the adjacent light source Q and the exit surface 5. The light of the associated light source Q on the other hand is directed via the light entry surface 8 and the first and second optical unit 1, 2 into the respective space 20 beamed through by light, on the light exit side of the base 9. In this manner, one prevents the quasi point-like light source Q appearing as such in the region of the exit surface 5. The inclination of the base 9 with respect to the first front end 104 is dependent on the light share which is reflected via the first front end 104 and is to be transmitted further in the body 102. The smaller slot-like cavities 10, which may be subdivided into root 13, trunk 11 and crown 12, finally serve for the fine setting of the light guided to the exit surface 5, with regard its intensity, distribution, alignment etc. They thus essentially effect the final light distribution at the exit surface 5.

The total effect of the optical units 1, 2 and of the light entry surface 8 together with the desired intensity—and propagation direction distribution of the light along the exit surface 5 of the second front ends 106 determines the shape of the slot-like cavities 10 of the third optical unit 3. This means that they influence the inclination of the base 9, as well as the design of the short slots 10 in particular, the design of the root 13, the trunk 11 and crown 10 with regard to their radii, or their design as straight lines, their inclination angle to one another and to the base 9.

The base 9 effects a reflection of most of the light which has not already been deflected by the other optical units 8, 1, 2 or elements 13, 11, 12 in the direction onto the exit surface 5. With the example shown here, the aim is to reflect where possible all light by way of this base 9 and to obtain an as high as possible light efficiency. However, a small share will always go through this base 9 as a result of unavoidable scatter procedures and inaccuracies, and then beam back in the direction of the first front end 104 as a loss.

The light reflected by the base 9 beams through and onto the other slot-like cavities, and is deflected by these bit by bit by way of reflection, refraction and transmission to the desired, final exit surface 5; again according to the laws of beam optics. Thereby, all further slot-like cavities 10 with root 13, trunk 11, crown 12 act as beam splitter mirrors. If the light is incident on these in a manner such that no total reflection is effected, the light is transmitted or refracted according to the optical laws, wherein a share of the light may also be reflected. If the light is incident such that total reflection arises, then all light is reflected. In both cases, it is the normal beam-optics procedures which apply to the reflected light: if the reflection surfaces are straight, then an undistorted image in the other direction arises, if they are curved, a corresponding focussing/defocusing, thus distortion of the image of the beamed in light occurs. The slot-like cavities 10 act in just the same way as lenses for the transmitted light, according to the laws of beam optics and light refraction. The common problems such as edge effects and dispersion problems are circumvented by way of the use of slot-like cavities 10 in the context of curved mirrors.

The exit surface 5 serves as the last optical element, in order to influence the light path. They may be formed in a planar manner or with spatial components, in order once again to give the light a different direction- or intensity distribution.

The optical device 1 shown here is manufactured from plexiglass. It is however conceivable to manufacture it as a plate of different, transparent, light-guiding material. In this example, the thickness of the plate is about 9 mm. Generally however, thicknesses between 0.5 mm and 20 mm are conceivable, preferably between 1 mm and 14 mm. The cavities 10 acting as optical elements according to the invention, are produced here by way of laser cutting, but may however also are taken into account already with the casting process. The surfaces of the cavities 10 are flame-polished, but other methods for smoothing and polishing these surfaces are also conceivable.

FIG. 5 shows a further embodiment of the optical device according to the invention, with which the crown 12 is designed flatter than in the example of FIGS. 2 to 4. The crown 12 plays a significant role as a beam splitter. If it is effected in a very flat manner, as in the example shown here, most light is already reflected at the crown 12, and never reaches other optical elements or also the first front end 104, in order to be transmitted further in the base body 102 and reflected there and/or modified in another manner.

For the example shown here, the curvature of the crown is responsible for the main part of the light distribution, and this light distribution is directed in a relatively large manner (small aperture angle). The options for the design are relatively limited. The light coming from the second optical unit 2 which is reflected directly at the crown 12, emits into the sector R. Again, the laws of beam optics and light refraction apply, which leave it open to the man skilled in the art, as how to influence the light distribution whilst observing the critical angle of the total reflection.

If the crown 12 is selected in a steep manner, as in the example shown in the FIGS. 2 to 4, almost all light beams through the root 13, the trunk 11 and the crown 12 up to the base 9, and is only gradually deflected into the sectors L and R in the sequence through the root 13, the trunk 11 and crown 12.

The options for producing different emitting characteristics of the whole optical device are extended essentially further in this case, since the light is deflected and divided several fold at each of the cavities 10 described above, according to the laws of light refraction and beam optics In this manner, one may realise light distributions with very large emitting angles in both sectors L and R.

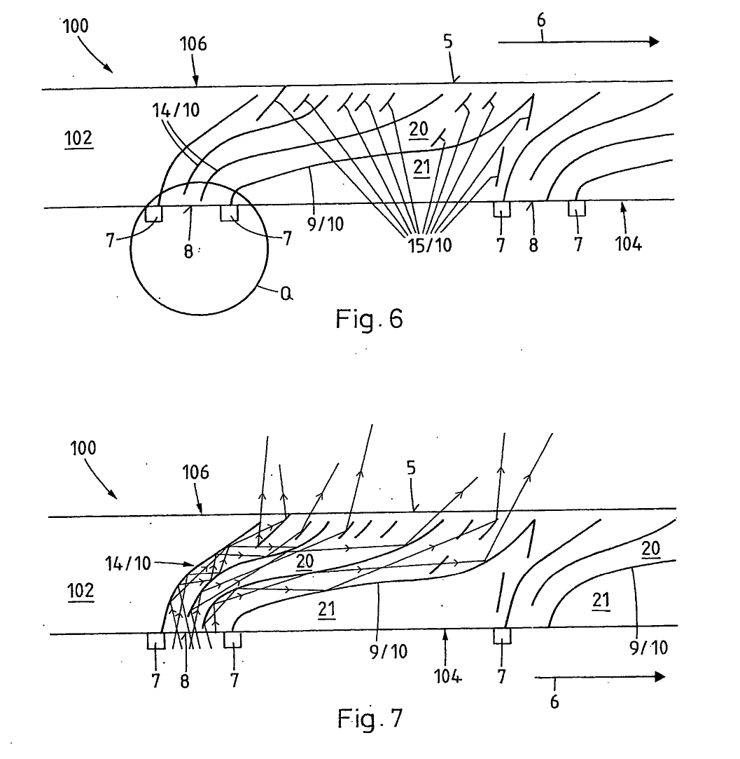

One embodiment of the optical device according to the invention is shown in the FIGS. 6 and 7, which serves for light distribution, without thereby the light from adjacent light sources Q being mixed. The slot-like cavities 10 and geometric shapes for this example, are indicated as follows: 8 again is the light entry surface, which as in the previous examples, may be designed as a lens or another optical element, depending on the light source 10 and the requirements in the base body 102 with regard to beam technology. The first optical element is indicated at 14, which here comprises slot-like cavities 10 acting essentially as guide elements, which direct the light into the space 20 beamed through by light, above the base 9. 15 indicates a second optical unit.

The light is coupled into the base body 102 of the optical device through the entry surface 8. The light of each discrete light source Q is directed separately through at least one long section of the first optical unit 14, as in a light channel, and is led into the space region 20 beamed through by light, on the light exit side of the base 9. Again the laws of light refraction and beam optics apply, within which the may skilled in the art may determine the distribution of the light by way of him designing the geometry of the first optical unit 14 according to the requirements. The first optical unit 14 is shaped such that the light is led in the general direction along the main axis 6 of the optical device 100.

In order to ensure an optimal distribution of propagation direction and intensity at the exit surface 5, one requires a second optical unit 15, consisting of several smaller slot-like cavities 10, which brings the light propagating in the light channel formed by the first optical unit 14, into the desired propagation direction distribution and intensity distribution. These slot-like cavities 10 thus simultaneously act as beam splitters, lenses and mirrors, and effect the final distribution of the light into the space to be illuminated, which may not be forced by the first optical unit 14 into this final distribution.

It is however evident that this variant of the optical device produces much more narrowly extended distributions of direction, than this is the case in the example of the FIGS. 2 to 5.

It is furthermore clear that by way of introducing further slot-like cavities 10, e.g. analogously to those in the third optical unit 3, of the examples from the FIGS. 2 to 4 and 5, which may act simultaneously as beam splitters, lenses and mirrors, again a large variety of light distributions may be achieved.

The exit surface 5 here serves as the last optics, and may be shaped in a planar or three-dimensional manner in order to give the exiting light once again a different direction—and intensity distribution. In particular, by way of the design of the exit surface 5, one may influence the direction distribution of the exiting light perpendicular to the plane spanned by the main axis 6 and the light axis Ax, thus out of the plane of the drawing. Fresnel lenses, holograms or simple optically curved surfaces may be incorporated or attached, which influence the light.

As may be well recognised in the figures, the units of light entry surface 8, optical units 1, 2, 3, 14, 15 and light exit surface 5 in the direction of the main axis 6 of the base body 102 of the optical device 100 according to the invention, are repeated periodically with the quasi point-like light sources Q. In order to achieve particular effects, it is conceivable to combine differently configured units of this type with one another in a base body 102 or optical devices 100, and to arrange them periodically in a repeating manner. Several base bodies with roughly the same outer dimensions may also be combined with one another without problem in the direction of their main axis 6. If the light distribution through the optical units 1, 2, 3, 14 15 and elements 13, 11, 12 of the adjacent regions is suitably designed, then the transition between the base bodies 102 or the optical devices 100 may not be recognised from the outside.

It is clear to the man skilled in the art on account of the complexity of the process described here, that the limits with regard to the light distribution to be realised may not be infinite. They are however extended much further than is the case with the previous devices.

There are minimal depths for the base body 102, in order to be able to cover the light sources Q with the base 9. The parabolas which deflect the light along a line, take up space, so that a minimal depth is given. This is more or less dependent on the emitting angle of the light sources Q. The wider is this angle, the more difficult it is to divert all light of a light source Q with the first optical device 1. However, the coupled-in light of the light source Q may be parallelised or even focussed with the help of a targeted design of the entry surface 8, and this space may be saved.

If an embodiment of the optical device is selected with a homogeneous light distribution, then the intensity distribution at the location of the illumination may be determined previously with the optical device according to the invention, with a previously defined tolerance. A light line is produced, with which the light is emitted without gaps, with no or only relatively small intensity fluctuations.

While the invention disclosed herein has been described in terms of several preferred embodiments, there are numerous alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. An optical device for producing light lines, the optical device comprising:
at least one quasi point-like light source;
a transparent, light guiding body configured such that light from the at least one quasi point-like light source is led through the body; wherein the light from the at least one quasi point light source is beamed in at a first front end of the body, and is beamed out again essentially at an opposite, second front end of the body; and
slot-like cavities provided in the body, wherein the slot-like cavities reform the beamed-in light in a manner such that the body acts as a combination of a reflector with lens optics and a light scatterer.

2. The optical device according to claim 1, wherein a long, slot-like cavity, which is provided as a base and extends from an associated light source in the direction of a main axis of the body, regionally divides the body into a space beamed through by light, and into a space which is not beamed through by light.

3. The optical device according to claim 2, wherein the base covers at least one adjacent light source and extends away from the associated light source in the direction of the main axis of the body.

4. The optical device according to claim 2, wherein the base is inclined with respect to the first front end, and in particular is inclined at different angles.

5. The optical device according to claim 4 wherein the base comprises curvatures in combination with straight lines, wherein the curvatures have different radii.

6. The device according to claims 2, wherein the base belongs to an optical unit which comprises further slot-like cavities, which extend essentially in the direction of a light exit surface, and which include three regions comprising a root, a trunk and a crown.

7. The device according to claim 6, wherein the crown determines intensity distribution and alignment of the light at the light exit surface.

8. The device according to claim 6, further comprising at least one further optical unit comprising slot-like cavities, wherein the light of an associated light source is directed into the space beamed through by light with the help of the at least one further optical unit.

9. The device according to claim 1, wherein light is coupled through a light entry surface into the body, wherein the light entry surface is designed as a lens, hologram or another optical element.

10. The device according to claim 1, wherein light exits from the body through at least one light exit surface, wherein the light exit surface is designed as a lens, hologram or another optical element.

11. The device according to claim 2, wherein the base forms an optical barrier between an adjacent light source and an exit surface.

12. A method for producing light lines by way of quasi point-like light sources, the method comprising:
beaming light from a quasi point-like light source into a first front end of a transparent light-guiding body;
directing light from the quasi point-like light source through the body, wherein the light on its way through the body is manipulated on slot-like cavities such that the body acts as a combination of a reflector with lens optics and a light scatterer; and
beaming light from the quasi point-like light source out of the body at an second front end which lies opposite the first front end.

13. The method according to claim 12 wherein the light of a light source is directed via a light entry surface and at least one optical unit into a space which is beamed through by light and is limited by the base on the light exit side of the base, and from there is coupled out of the body.

14. The method according to claim 12 wherein the slot like cavities comprise a long, slot-like cavity, which is provided as a base and extends from an associated light source in the direction of a main axis of the body, and regionally divides the body into a space beamed through by light and into a space which is not beamed through by light.
